(19) United States
(12) Patent Application Publication
(10) Pub. No.: US 2017/0050072 A1
(43) Pub. Date: Feb. 23, 2017

(54) Case with weights for adding weight to a bicycle

(71) Applicant: Mark Edward Connelly, Oak Park, CA (US)

(72) Inventor: Mark Edward Connelly, Oak Park, CA (US)

(21) Appl. No.: 14/949,340

(22) Filed: Nov. 23, 2015

Related U.S. Application Data
(60) Provisional application No. 62/207,925, filed on Aug. 21, 2015.

(51) Int. Cl. A63B 21/06; A63B 22/06; B62J 99/00

(52) U.S. Cl. CPC A63B 21/0605; B62J 99/00; A63B 22/0605

(57) ABSTRACT

The present invention is a case that holds weight material and is used to add weight to a bicycle. The case is attached to a bicycle frame at various locations via a plurality of attachment straps. The case can be attached to a bicycle frame top tube, down tube or in front of a seat tube. The weight material is removable and can be loaded directly into the case or into one or more removable weight pouches that are inserted into the case. The weight of the case is adjustable by adding or subtracting weight as needed. Weight pouches are segmented to enable the weight amount to be reduced incrementally and to help keep the contents from moving around.

### BACKGROUND OF THE INVENTION

1. Field of the Invention

The present invention is in the technical field of exercise and sport. More particularly, the present invention is in the technical field of bicycling. More particularly, the present invention is in the technical field of weights for strength building. More specifically the present invention relates to adding weights to a bicycle.

Currently, high-end, top level bicycles are made from light weight materials like carbon fiber, aluminum alloys and titanium. Light weight bicycles make cycling easier, especially for certain aspects of cycling like climbing up a hill. This is good for competition or for other reasons where a light weight bicycle is desired. However, for training and strength building, a light weight bicycle does not contribute as much to strength building as a heavier bicycle would. By attaching one or more weighted cases to a bicycle, the cyclist can use the extra weight as a strength training tool. By adding weight to the bicycle the cyclist uses to compete with, or onto the bike they ride on a regular basis, the rider can maintain the feel and responsiveness of the bike, but add weight to help build strength.

2. Description of Prior Art

Weights have been used for centuries by people for use in sports, sports training, and for gaining strength. Weights are often carried in the user's hand, or carried in a device strapped to the user. In relation to cycling, adding weights to a bicycle was proposed in U.S. Pat. No. 5,752,898 issued to Porkka. This patent describes a weight device that is angled to fit under a bicycle frame down tube, bottom bracket, and chain stays. The design is limited because it is intended to be positioned only at that one location on a bicycle frame. The amount of weight that can be attached to a bicycle using the device is also limited because more than one device cannot be attached to the same bicycle frame.

### SUMMARY OF THE INVENTION

Broadly, the present invention described herein is a case with removable internal weights. The case attaches to a bicycle frame with a plurality of securing fasteners. The case can be situated at more than one location on a bicycle frame. More than one case can be attached to a bicycle frame at the same time. When attached to a bicycle frame the case serves the purpose of adding weight to a bicycle in order to make it heavier. The added weight helps the cyclist build strength.

The case is comprised of an elongated, linear, hollow, circular or non-circular shaped housing with a cap on one side that opens to allow the insertion of and removal of weight material and a closed side on the opposite end. In the preferred embodiment of the present invention, the top exterior surface of the elongated housing has surface with a concave up shaped profile. The concave up shaped surface is an abutting surface that abuts a surface of the bicycle when the housing is secured to the bicycle. That is, the housing rests against a bicycle frame tube member when the case is attached to a bicycle frame. The concave up shaped surface allows for a more stable position against both flat and rounded bicycle frame tubes. In other embodiments, the abutting surface can be concave down or the abutting surface can be flat.

One object of the present invention is to provide a case that holds weight material where the amount of weight may be increased or decreased as desired by inserting or removing the weight material. Weight material can be comprised of solid metal bar sections, metal rods, metal balls, metal shot, metal sand, metal powder, metal filings or a combination of said material. The weight material can be loaded directly into the cavity of the case, or the weight material can be loaded into one or more pouches that hold a specific amount of weight and said pouches are inserted directly into the cavity of the case. Besides holding a specific amount of weight, the weight pouches can optionally be designed to be re-sized by way of an internal closure mechanism that is located a set distance from the opening of the pouch. A pouch with one or more internal closure mechanisms is a segmented pouch that enables some of the weight material to be removed from the pouch and then sealed at the segments to prevent movement of the remaining weight material. The segmented pouch design will also facilitate reducing the weight to set amounts.

Weight material can be composed of various grades of steel, steel alloys, iron, or from various other metals such as brass, zinc, copper, etc., or any combination of metals which provide the desired weight. Which metal type used would be based on price, availability, and the desired weight. Although lead has a high weight to volume ratio, the use of lead, or other toxic metals, is not recommended due to health concerns. Ultimately, the type of weight material used and the quantity will affect the overall weight of the case.

It is a further object of the present invention that the case can be attached to the bicycle frame at multiple locations and more than one case can be attached to a bicycle frame at the same time. For example, the case can be attached to the underside of a bicycle frame top tube, to the underside of a bicycle frame down tube, and in front of a bicycle frame seat tube. The location of the present invention will be partially dictated by different frame designs as bicycle frames come in wide range of design styles. For heavy loads, the design of the present invention is beneficial as it allows the attachment of more than one case at different locations of a bicycle frame. This allows the weight to be distributed more evenly versus what would be achieved by attaching one heavy load to one location. For example, a weight of 7.3 kilograms or 16 pounds located at one location could change the ride feel of the bike compared to two 3.6 kilogram or two 8 pound weights located at two different locations on the bicycle frame.

In another object of the invention, the size of the case is designed to account for the load bearing strength of bicycle frame tubes. Because bicycle frames are designed for different purposes and uses, manufacturers will build bicycle frames with different weights and strengths. A bicycle frame designed for climbing on smooth roads will be lighter in weight than a bicycle frame designed for general use or for use on rough roads. In particular, high-end bicycle frames are often built out of thin-walled tubing or made using thin-walled construction methods. As an example, bicycle frames made from carbon fiber often have top tubes with thinner walls and down tubes with thicker walls. The thinner walled construction of the top tube on many high-end, light weight bicycle frames may not be strong enough to support a heavy weight attached to it.

To accommodate for the weight-bearing load strength of various frame designs, the present invention is designed to hold weight material within a preferred weight range and the length of the present invention is long enough to distribute the desired weight over a longer surface area. For bicycle frame designs that have thinner tubing, the present invention limits the amount of weight material that can be stored inside the case to under a recommended weight limit of 4.5 kilograms or 10 pounds. This is accomplished by limiting the interior volume of the case to a size that keeps the weight below 4.5 kilograms or 10 pounds. The type of weight material used can also dictate the size of the case. For example, metals like lead are heavier by volume than steel. For bicycle frame designs that have thicker and stronger walled tubing, the present invention does not limit the interior volume of the case to a size that keeps the weight below 4.5 kilograms or 10 pounds. Bicycle frames made from thicker-walled carbon fiber, aluminum, titanium, and steel may not have weight limitations that are of concern. In this case, the recommended weight limit of less than 4.5 kilograms or 10 pounds may not be a factor and the present invention can be designed to hold over 4.5 kilograms or 10 pounds of weight material inside the case. In the preferred embodiment of the present invention it is also recommended that the case has a linear length that distributes the weight bearing load over a longer surface area. For example, if two cases both weigh 3.6 kilograms or 8 pounds, but one has a linear length of 32 cm or 12.5 inches and another case has a linear length of 12.5 centimeters or 5 inches, the longer case will distribute the weight over a longer distance than the shorter length case when the case is attached to the underside of a bicycle frame top tube or down tube. The longer case will distribute the load further apart and will put less stress on the area where case is attached.

In all embodiments of the present invention, the recommended weight limit applies to one location on the bicycle frame, such as a top tube, and not to the overall weight. As an example, one case that hold 3.6 kilograms or 8 pounds of weight can be attached to a bicycle frame top tube and another case holding 3.6 kilograms or 8 pounds of weight can be attached to a bicycle frame down tube.

If the preferred embodiment of the invention is destined to be universally useable on all bicycle frames, then the case will be designed and manufactured to hold less than 4.5 kilograms or 10 pounds of weight material. If the preferred embodiment of the invention requires the case to hold 4.5 kilograms or 10 pounds or more of weight material, then the case may not be universal for use on all bicycle frames. The case would be specifically designed and manufactured for specific frame types.

It is another object of the preferred embodiment of the present invention that the case is designed with a size, shape and profile that allows it to hold a desired amount of weight without it impinging on the normal use of a bicycle. The width of the case, as being measured from the left side of a bicycle to the right side of a bicycle, is not so wide as to interfere with the cyclist's legs when the case is attached to the underside of a bicycle frame down tube or attached to the front side of a bicycle frame seat tube. The case should also not come in contact with the inner chain ring of the bicycle crank or the left crank arm when the case is attached to the underside of a bicycle frame down tube or attached to the front side of a bicycle frame seat tube.

In another preferred embodiment of the present invention, the length, and most importantly, the height of the case, as being measured from the upper surface of the long side of the case, which is the side that abuts against the bicycle frame tube, to the opposite side, should not prevent the use of standard size water bottles of about 500 milliliters or 17 ounces inserted into water bottle cages, which are attached to the bicycle frame seat tube or down tube, for most adult bicycle frame sizes. For example, if the case is attached to the underside of a top tube then the height of the case should not prevent the cyclist from being able to insert a standard size water bottle of about 500 milliliters or 17 ounces into a water bottle cage attached the bicycle frame down tube or seat tube. If the bottom surface of the case is too close to a water bottle cage, it may block the entrance to the water bottle cage enough so a water bottle can not be inserted. In other embodiments of the present invention, the height of the case may be tall enough to interfere with the use of standard size water bottles but the benefit of a taller case with more weight may supersede the need to use a standard size water bottle by the cyclist.

Also, it should be noted that since bicycle frames comes in various sizes and the position of water bottles on a bicycle frame will vary from one bicycle model to another bicycle model and from one bicycle manufacturer to another bicycle manufacturer, the case should accommodate the desired maximum weight and have a size that will accommodate the average adult bicycle. Because bicycle frames do come in a wide range of sizes and designs, the present invention can be manufactured with one universal size to fit most bicycle frames, and additionally, the present invention can be manufactured in multiple height and length combinations. A case intended for use on larger bicycles frames can be longer and taller than a case intended for use on smaller bicycle frames.

In another preferred embodiment of the present invention, when the case is attached to the underside of a bicycle frame down tube, the length, height, and position of the case should not cause the bottom side of the case to rub against the tire of the front wheel of the bicycle. The distance between the down tube and the front wheel of a bicycle varies based on the bicycle design. A road bicycle will place the front wheel closer to the frame than a mountain bicycle would. If multiple case sizes are manufactured, then it would be plausible for users of larger bicycle frames sizes to attach a longer case to the underside of a bicycle frame top tube and a shorter case to the underside of a bicycle frame down tube since a longer case may rub against the tire of the front wheel.

Other features and advantages of the present invention should become apparent from the following description of the preferred embodiment, taken in conjunction with the accompanying drawings, which illustrate, by way of example, the principles of the invention.

### BRIEF DESCRIPTION OF THE DRAWINGS

FIG. 1 is a perspective view of the case as viewed from the side and top. It shows an open cap and concave up shaped upper surface.

FIG. 2 is a perspective view showing the bottom of the case and two weight pouches filled with weight material.

FIG. 3 is a sectional view from the front of the case showing the concave up shaped upper surface.

FIG. 4 is a perspective view of the case attached to a bicycle down tube.

FIG. 5 is a perspective view of the case attached to a bicycle top tube.

FIG. 6 is a perspective view of the case attached to a bicycle top tube. It shows an alternative strap attachment method.

FIG. 7 is a perspective view of a weight pouch that is filled half way with weight material comprised of metal balls.

FIG. 8 is a perspective view of the case attached to a bicycle seat tube.

FIG. 9 is a perspective view of a section of the case and a strap with a plastic buckle.

FIG. 10 is a perspective view of the case as viewed from the side and top with a section cut out, which reveals weight material inside the case comprised of small metal balls.

### DETAILED DESCRIPTION OF THE INVENTION

All descriptions and drawings are for the purpose of describing a selected version of the present invention and are not intended to limit the scope of the present invention. It is also to be understood that the phraseology or terminology employed herein is for the purpose of description and not of limitation.

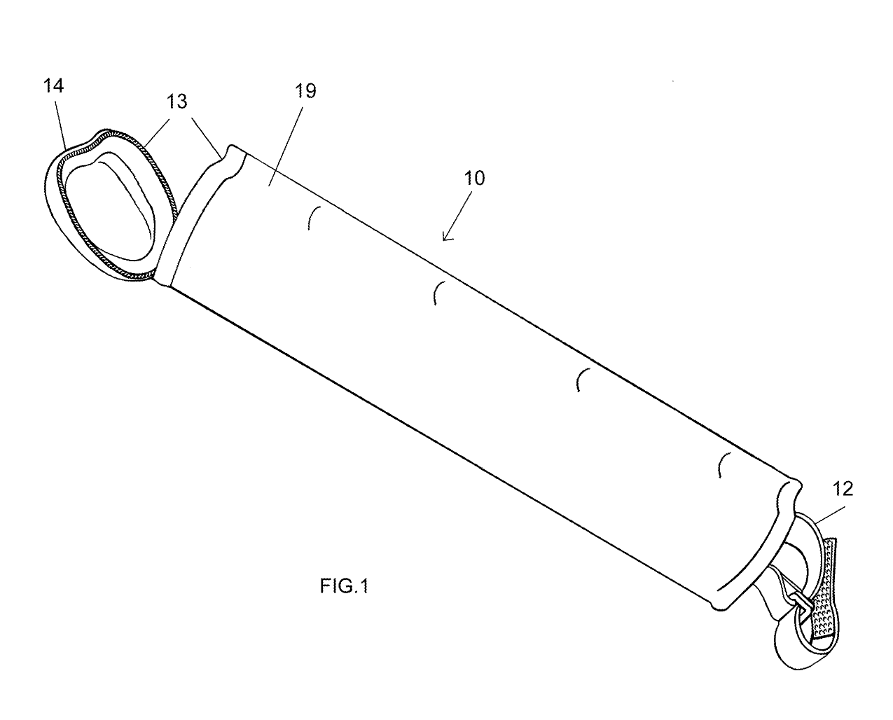

Referring now to the invention in more detail, FIG. 1 is a perspective view of the case 10 as viewed from the side and top. The case 10 is comprised of an elongated, hollow, circular or non-circular shaped housing with a concave up shaped upper surface 19. The case 10 opens on one side via a cap 14 with a zipper 13. The opposite end is permanently closed and has a strap 12 attached to it. The concave up shaped upper surface 19 is used to help stabilize the case when attached to a bicycle frame. Most bicycle frames tubes have round, flat, or oval shaped surfaces. The concave down upper surface abuts against the bicycle frame tube.

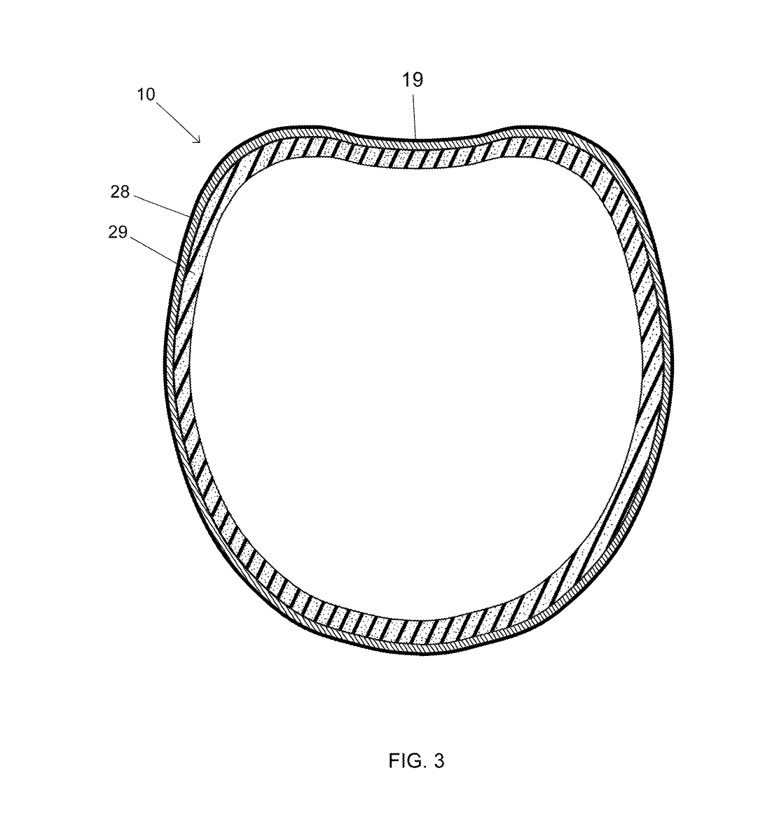

The case 10 and cap 14 can be comprised of many materials. In the preferred embodiment, the interior space of the housing has an interior surface comprised of a semi-rigid material and the exterior surface comprises a fibrous material. The case can be made from EVA foam with a fabric laminate, neoprene fabric, or from various fabrics with dense foam padding sandwiched between two layers of fabric. It will be clear to those skilled in the art, in light of this disclosure, that a variety of materials may be used alone or in combination to provide both padding and rigidity for the case. Alternatively, the case 10 and cap 14 can also be injection molded out of various plastics or made from metal. As molded plastics and metal are very rigid, foam padding or neoprene can be attached to the outside of the case 10 along the entire length of the upper surface 19, which will provide cushioning and protection of the bicycle frame tubes, when the case 10 is attached to a bicycle frame. Both cost and design will dictate which type of material is preferred. Nylon or polyester fabrics laminated to EVA foam are durable, flexible, provide intrinsic padding and stiffness, and can be molded. The padding protects both the bicycle frame and the contents of the case. The present invention as illustrated in FIG. 1 shows the preferred embodiment of the case 10 made from polyester or nylon fabric laminated to EVA foam. The case 10 may be molded or not molded. FIG. 3 shows a cross section of the case 10 with an outer fabric layer 28 and an inner EVA foam layer 29. The fabric is bonded to the EVA foam. The two end caps are molded and are made from polyester or nylon fabric laminated to EVA foam. The strap 12 attached to the closed-end side of the case 10 can be permanently attached to the case 10 or it can be made to be removable.

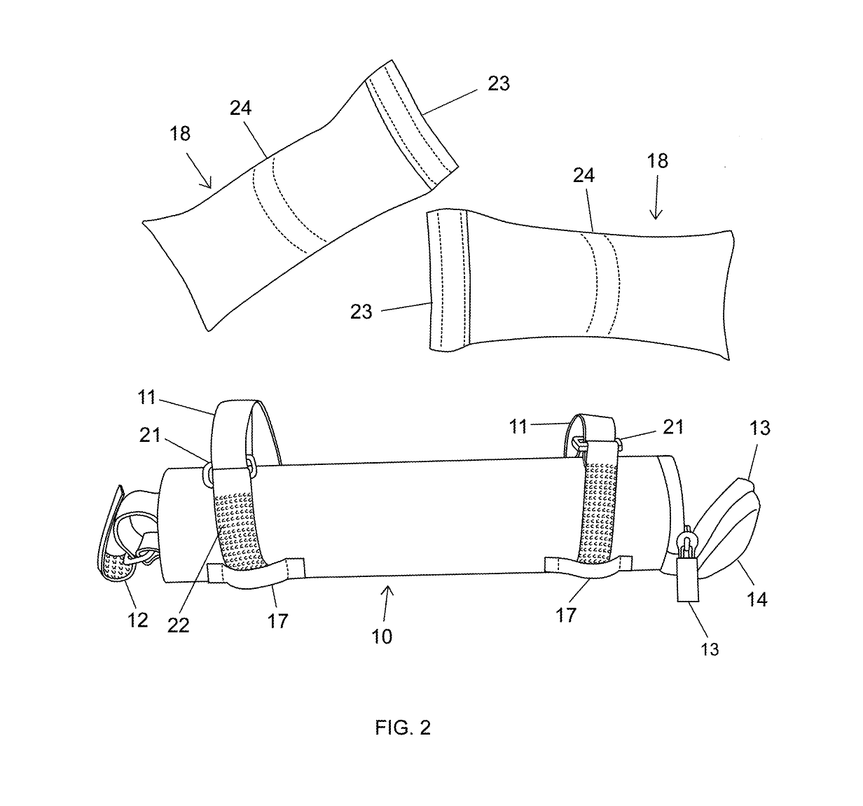

Referring to the invention in FIG. 2, the illustration shows a perspective view of the case 10 from a bottom, side view perspective and two weight pouches 18. The weight pouches 18 can be filled with weight material comprised of solid metal bar sections, metal rods, metal balls, metal shot, metal sand, metal powder, metal filings or a combination of said material. The case 10 can hold one weight pouch 18 or a plurality of two of more weight pouches 18. Ultimately, the length and width of the case 10 and the length and width of the weight pouches 18 will dictate how many pouches 18 can be inserted into the cavity of the case 10. FIG. 2 shows a case 10 designed to hold up to two full weight pouches 18 of a specific size and weight. The case 10 can also be filled with metal weights without the use of weight pouches 18. The length of the case 10 as measured from the cap 14 side of the case 10 to the opposite side can vary based on the desired weight amount the case 10 will hold, but it is preferable for the case 10 to be a length that will distribute the weight over a longer area. Generally a length of 28 centimeters or 11 inches or more is recommended as a starting reference size. The intended use of the case 10, the weight of the case 10, and the type of weight material inserted into the case 10 will be some of the factors which help determine the chosen length of the case 10.

Referring now to FIG. 2, two securing fasteners are straps 11 located at both ends of the case 10. The positions of the straps 11 are set by belt loops 17 attached to the bottom of the case 10. The belt loops preferably have an inside width, which is the distance between inside attachment points, wider than the width of the straps 11 to allow slight position changes of the straps 11. The straps 11 are preferably 1.9 centimeters or 0.75 inches wide, but the width can be wider. The straps 11 have hook and loop fasteners 22 to provide the attachment mechanism. Straps with hook and loop fasteners 22 have a squared ring 21 that allows the strap to be fed through the ring in order to cinch down the straps 11 and adjust the tension when securing the case to a bicycle frame. Each strap 11 wraps around both the case 10 and a bicycle frame tube and attaches to itself with the hook and loop fasteners 22. This attachment method is very strong. Alternatively, as illustrated in FIG. 9, the straps 11 can use a plastic buckle 27 as an attachment mechanism. The straps 11 are preferably removable since removable straps are more useful if a strap needs to be moved or replaced. If the straps 11 are not removable, they will be attached at one or more locations on the case 10. Alternatively, as illustrated in FIG. 6, the straps 11 can be attached to the upper surface 30 of the case 10 and wrap around a bicycle frame tube. This attachment method is not as strong, since it would put stress on the case 10 where the strap 11 is attached to, but may be preferred for aesthetic or other reasons. The straps 11 are preferably made from nylon or polyester woven strapping material but can also be comprised from other materials.

As illustrated in FIG. 2, the cap 14 at the front end of the case 10 has a clamshell style opening. It attaches at the bottom of the case and opens and closes via a closed-end zipper 13. The zipper 13 extends around the perimeter of the cap 14 and the case 10. The cap 13 is not removable. The zipper 13 can be of many types, but a hidden zipper style is preferred for the present invention. A hidden zipper has material that covers the zipper teeth. This is beneficial to the present invention as it prevents the zipper teeth from coming into contact with the tubing of a bicycle frame.

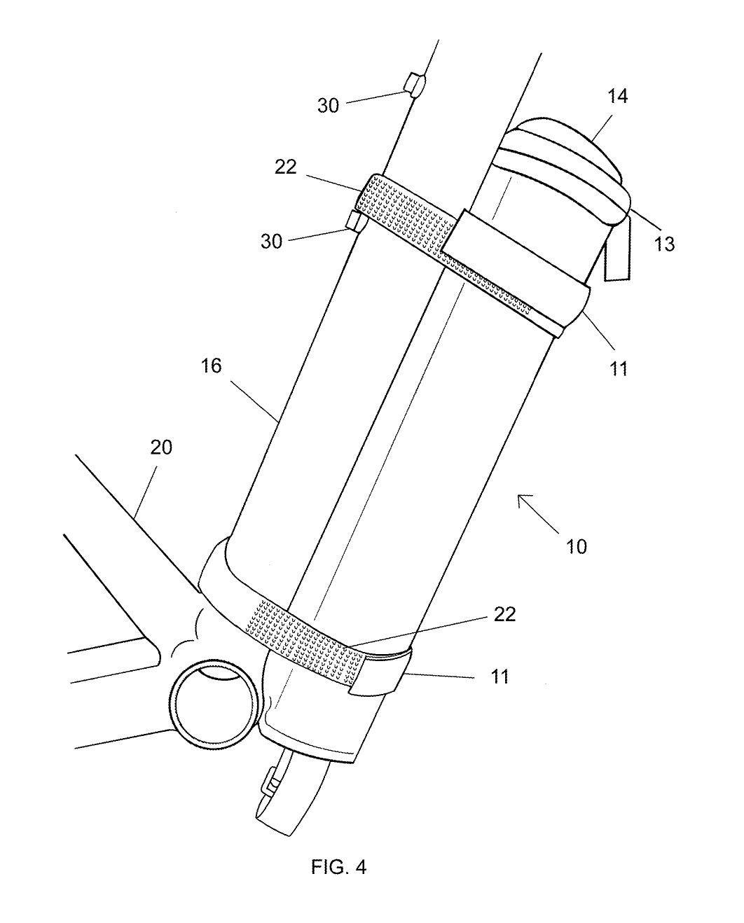

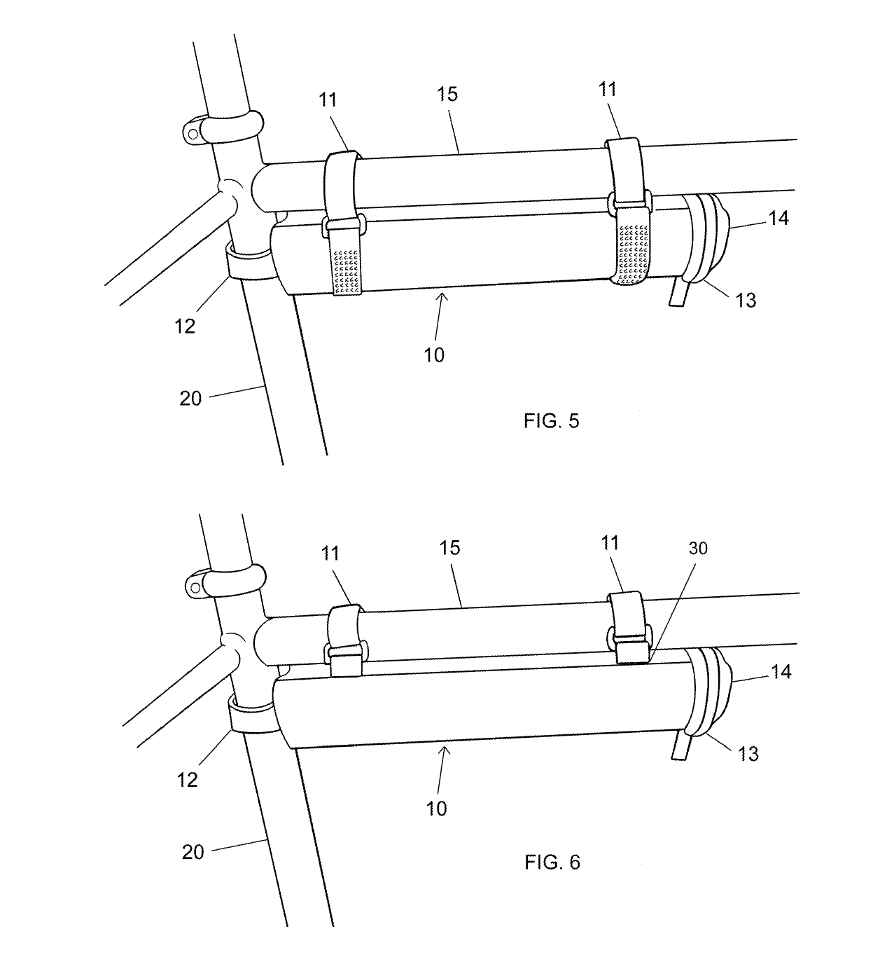

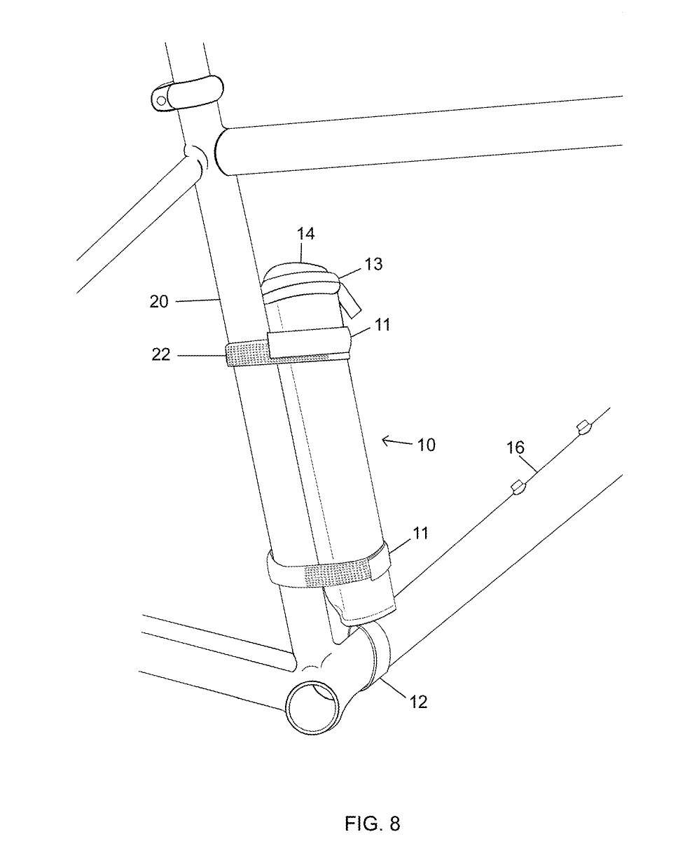

Referring now to FIG. 3, the illustration shows a cross section of the case 10 as viewed from the front end of the case. The case 10 shape can be rounded, ovalized, teardrop, squared, or any other shape, but will have a concave up shaped upper surface 19. The width of the case 10, which is the distance from the left side outer edge to the right side outer edge in FIG. 3, can vary but should not be so wide as to touch the bicycle rider's legs during pedaling or moving parts of the bike. Generally, an outside width between 5.7 centimeters and 6.35 centimeters or 2.25 and 2.5 inches is a recommended outside width as this is narrower than the width of a bicycle frame bottom bracket shell. The height of the case 10 can vary, but ideally, it should not be so tall as to interfere with the use of standard size water bottles of about 500 milliliters or 17 ounces, which are attached to the bicycle frame down tube 16 as seen in FIG. 8 or attached to the seat tube 20 as seen in FIG. 5 via water bottle cages, for most frame sizes. If the case height is too tall, then it could prevent a user from being able to insert a water bottle into a water bottle cage. Additionally, if the case 10 is attached to the bottom of a bicycle down tube 16 as seen in FIG. 4, the height of the case 10 should not cause the case 10 to rub against the tire of the front wheel of a bicycle. Generally, an outside height between of 6.35 centimeters or 2.5 inches is a recommended height for a case designed to fit a large size range of adult bicycles. However, the height measurement for the case is not set to one size and will ultimately be determined by the intended use of the case. The overall interior volume of the case 10 should account for the weight limit of the bicycle frame tubing. If the present invention is intended to be attached to high-end, light weight bicycle frames, then the case 10 should have a volume that keeps the overall weight of the present invention to fewer than 4.5 kilograms or 10 pounds. If the intended use for the present invention is to be attached to bicycle frames of sturdier construction, then the weight limit may not be a factor. High-end racing bikes are often made from tubing and materials that are thinner and lighter. Each manufacturer can have different specifications for tubing strength, so weight limits for the case 10 could change to accommodate.

Referring now to FIG. 4, the illustration shows the case 10 attached to a bicycle frame down tube 16 with two fastening straps 11. Each strap 11 wraps around both the case and the bicycle frame down tube 16 and attaches to itself with hook and loop fasteners 22. The case 10 is positioned along the down tube 16 so lower strap 11 rests against the seat tube 20. Attaching the case 10 in this manner will help keep the case 10 from sliding, which would be due to the angle of the down tube 16. Depending on the position of water bottle cage bosses and bolts 30 located along the down tube 16, the upper strap 11 may or may not end up situated above one of the water bottle bolts 30.

Referring now to FIG. 5, the illustration shows the case 10 attached to a bicycle frame top tube 15 with two fastening straps 11. Each strap 11 wraps around both the case and the bicycle frame top tube 15 and attaches to itself with hook and loop fasteners 22. This attachment method is very strong. A third fastening strap 12 is attached to the back end of the case 10 and wraps around the bicycle frame seat tube 20 and attaches to itself with hook and loop fasteners. This strap 12 is a stabilizing fastener and not a weight bearing fastener. The strap 12 helps reduce side to side movement of the case 10 when the case 10 is attached to a bicycle frame tube. Its use by the user is optional.

Referring now to FIG. 8, the illustration shows the case 10 attached to a bicycle frame seat tube 20 with two fastening straps 11. Each strap 11 wraps around both the case and the bicycle frame seat tube 20 and attaches to itself with hook and loop fasteners 22. This attachment method is very strong. A third fastening strap 12 is attached to the back end of the case 10 and wraps around the bicycle frame down tube 16 and attaches to itself with hook and loop fasteners. This fastening strap 12 is a stabilizing strap and not a weight bearing strap. Its use by the user is optional, but is recommended to help prevent the case from moving from side to side if the straps 11 are not tightened down enough.

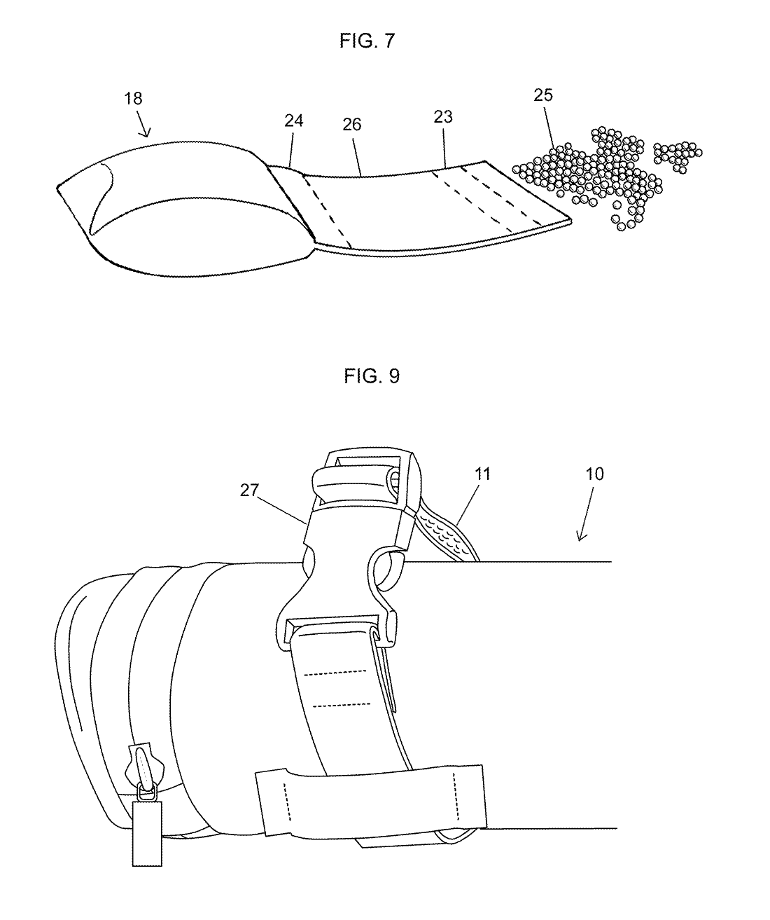

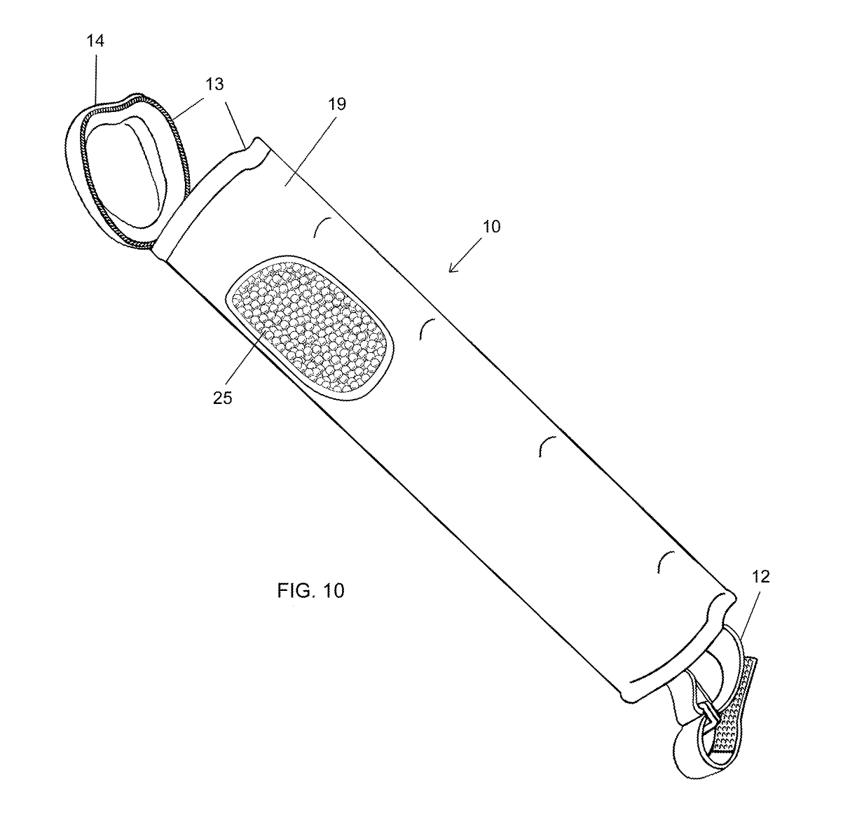

The case 10 is generally loaded with weight material comprised of solid metal bar sections, metal rods, metal balls, metal shot, metal sand, metal powder, metal filings or a combination of said material. The case 10 can be filled loosely filled with weight material, or the case 10 can be loaded with weight pouches 18 containing weight material as illustrated in FIG. 2. FIG. 10 illustrates a case 10 filled directly with weight material 25 comprised of small steel or iron balls. Weight pouches are not used in the FIG. 10 example. As illustrated in FIG. 2, the use of weight pouches 18 is preferred because the pouches 18 help to retain the material and keep the material from moving around as easily. Weight pouches 18 in FIG. 2 can be made from various fibrous fabrics like ripstop nylon, or from flexible plastic like polyethylene. The pouches 18 can be sealed in many ways depending on the material used and the type of closure mechanism used. To accommodate various weight amounts, the pouch 18 is designed to close at the top 23, and optionally, in the middle 24 of the pouch 18. The pouch 18 as shown in FIG. 2 is an example of a fibrous fabric pouch 18 sealed at the top 23 by way of an internal closure mechanism comprised of hook and loop fasteners. As illustrated in FIG. 7, to reduce the weight to about half, the metal weights 25 are removed from the top half 26 of the pouch 18 and sealed in the middle section 24 by way of an internal closure mechanism comprised of hook and loop fasteners attached to the inside of the pouch 18. If one pouch 18 is inserted into the case 10 then the case 10 will be approximately half the weight as a fully loaded case 10. If the weight material 25 is removed from one half of one pouch 18 and the second pouch 18 is fully loaded, then the total weight of the case 10 will be one quarter of the total weight lighter. The segmented pouch design enables adjustability of the weight closely to set amounts without the requiring the need for a weight scale. Additionally, the remaining weight material left inside the pouch is secured more to help reduce shifting around of the weight material.

Alternatively to the preferred embodiment previously illustrated, if the case 10 and cap 14 are made from injection molded plastic the following are possible design considerations. The cap 14 can open in various ways with different styles of opening mechanisms. The cap 14 can have a screw on mechanism or it can have a hinge and clasp style mechanism. The case 10 may have foam padding or neoprene attached to the upper concave up shaped surface 19 to provide cushioning and stability. Additionally, the straps 11 may or may not need to wrap around the case 10. The fastening straps 11 can wrap around the case 10 or can be attached close to the upper top surface, which abuts a bicycle frame tube, of the case 10. The type of fastening straps 11 and 12 used with an injection molded case 10 can be made from many fibrous and non-fibrous materials. Fastening straps 11 and 12 can be comprised of nylon or polyester webbing, as previously described, or fastening straps 11 and 12 can be comprised of flexible plastic with a ratcheting buckle mechanism. The case 10 can also be custom made and molded to fit a particular bicycle frame tube shape.

It should be appreciated from the foregoing description that the present invention provides a way to add weight to a bicycle. The case has the benefit of allowing weight material of various types to be inserted or removed. Weight material can be inserted directly into the case, or it can be contained within pouches that are inserted into the case. The weight pouches can be segmented to allow the weight to be reduced or increased incrementally. Because more than one case can be attached to a bicycle frame at the same time, the user of said weighted cases can increase the weight beyond the weight provided by one case.

It also should be appreciated that the invention has been described in detail with reference only to the presently preferred embodiment. Various modifications can be made without departing from the invention. Other embodiments will be apparent to those skilled in the art from consideration of the specification and practice of the invention disclosed herein and by the claims.

I claim:

1. A case for adding weight to a bicycle comprising:
a housing having an interior space and an exterior surface, wherein at least a portion of the interior space is sized and dimensioned to receive a plurality of weights;
a plurality of securing fasteners for securing the housing to the bicycle; and wherein the exterior surface of the housing has an abutting surface that abuts a surface of the bicycle when the housing is secured to the bicycle, wherein the abutting surface has a contour that is sized and dimensioned to receive the surface of the bicycle.

2. The case of claim 1, wherein the housing is linear.

3. The case of claim 1, wherein the contour of the abutting surface is concave.

4. The case of claim 1, wherein the housing comprises flexible material.

5. The case of claim 1, wherein the housing comprises a single piece.

6. The case of claim 1, further comprising a stabilizing fastener for stabilizing the case.

7. The case of claim 1, wherein at least a portion of the interior space is sized and dimensioned to receive a plurality of pouches.

8. The case of claim 1, wherein the housing comprises at least two materials.

9. The case of claim 1, wherein a cross section of the housing has a concave portion and a convex portion.

10. The case of claim 1, wherein a cross-section of the housing is one of round, ovalized, squared, oblong, or teardrop shaped.

11. The case of claim 1, wherein the interior space of the housing has an interior surface comprised of a semi-rigid material and the exterior surface comprises a fibrous material.

12. A method of adding weight to a bicycle comprising:
attaching a first case, having a housing with an exterior surface and an interior space, to a first portion of a bicycle;
wherein the exterior surface of the first case has an abutting surface that abuts a surface of the bicycle when attached to the bicycle, wherein the abutting surface has a contour that is sized and dimensioned to receive the surface of the bicycle; and
wherein at least a portion of the interior space of the first case is sized and dimensioned to receive a plurality of weights.

13. The method of claim 12, wherein the contour of the abutting surface is concave.

14. The method of claim 12, wherein the first case comprises flexible material.

15. The method of claim 12, wherein a cross section of the first case has a concave portion and a convex portion.

16. The method of claim 12, wherein the first case can be of different shapes such that a cross-section of the first case can be round, ovalized, squared, oblong, or teardrop shaped.

17. The method of claim 12, further comprising adding at least one weight to the first case.

18. The method of claim 12, further comprising:
detaching the first case from the first portion of the bicycle; and attaching the first case to a second portion of the bicycle different from the first portion.

19. The method of claim 12, further comprising attaching a second case having a housing with an exterior surface and an interior space, to a second portion of a bicycle;
wherein the exterior surface of the second case has an abutting surface that abuts a surface of the bicycle when attached to the bicycle, wherein the abutting surface has a contour that is sized and dimensioned to receive the surface of the bicycle; and
wherein at least a portion of the interior space of the second case is sized and dimensioned to receive a plurality of weights.

20. The method of claim 12, further comprising stabilizing the first case when attached to the bicycle.
